(19) United States
(12) Patent Application Publication
(10) Pub. No.: US 2008/0106057 A1
(43) Pub. Date: May 8, 2008

(54) Method and apparatus for engaging and disengaging a slider box assembly

(76) Inventor: C. Michael Smith, Portage, MI (US)

Correspondence Address: DAVID P DURESKA;BUCKINGHAM DOOLITTLE & BURROUGHS, LLP, 4518 FULTON DRIVE, NW, P O BOX 35548, CANTON, OH, 44735-5548, US

(21) Appl. No.: 11/594,354

(22) Filed: Nov. 6, 2006

(51) Int. Cl. B62D 53/10

(52) U.S. Cl. 280/149

(57) ABSTRACT

An apparatus for engaging and disengaging a slider box assembly and a method of use of the same is disclosed. The slider box assembly has a first slider rail, a second slider rail, a bladder and an actuator bar. The actuator bar extends substantially parallel to the slider rails. The bladder extends from one of the slider rails to the actuator bar to selectively rotate the actuator bar.

### FIELD OF THE INVENTION

The present invention relates to a method and apparatus for locking and unlocking a slider box assembly on a vehicle, such as a slider box assembly on a semi-trailer.

### BACKGROUND OF THE INVENTION

Slider box assemblies for vehicles, such as semi-trailers, are well-known devices that typically support at least a portion of the suspension for the semi-trailer as well as one or more axles. The slider box assembly is longitudinally movable with respect to the semi-trailer main frame so that the load in or on the semi-trailer can be distributed on the axles.

Once the load has been properly distributed over the axles, the slider box assembly is secured to the semi-trailer main frame. Typically, the slider box assembly is secured to the semi-trailer main frame by a mechanism that extends and retracts a plurality of pins that ride with the slider box assembly into and out of apertures in the semitrailer main frame. The mechanism that moves the pins can be manual or fluid driven, such as by air or liquid.

Most modern pin mechanisms are manually engaged and disengaged. Whether they are manually or automatically engaged or disengaged, however, the prior art pin mechanisms suffer from the disadvantage of being heavy, too complex, too expensive and having too many parts. Furthermore, the prior art fluid driven pin mechanisms often fail to have an inexpensive and easy to use mechanical override that permits an operator to operate the system when the fluid driven system is not operational.

### SUMMARY

One embodiment of a slider box assembly has a first slider rail, a second slider rail, a bladder system and an actuator bar. In this embodiment, one end of the bladder system may be connected to one of the slider rails and the other end of the bladder system may be connected to the actuator bar. Inflation and deflation of the bladder system moves the actuator bar to engage and disengage the slider box assembly from a vehicle.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a schematic, perspective view of one embodiment of a slider box assembly, bladder system and actuator bar among other structures;

FIG. 2 is a perspective view of certain features from FIG. 1;

FIG. 3 is a perspective view of certain features from FIG. 1;

FIG. 4 is a perspective view of certain features from FIG. 1;

FIG. 5 is a perspective view of certain features from FIG. 1;

FIG. 6A is a perspective view of certain features from FIG. 1; and

FIG. 6B is a perspective view of certain features from FIG. 1.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

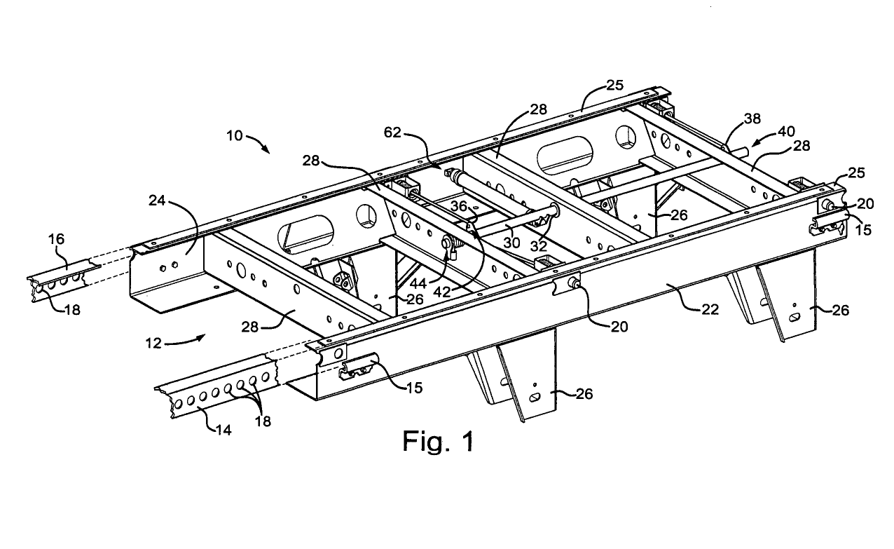

Referring now to FIG. 1, one embodiment of a slider box assembly 10 is depicted as well as a portion of one embodiment of a semi-trailer frame 12. The slider box assembly 10 depicted is merely one exemplary embodiment. Slider box assemblies having different shapes, sizes and designs are not to be excluded.

The portion of the semi-trailer frame 12 that is depicted comprises a first body rail 14 and a second body rail 16. Only a portion of each body rail 14, 16 is depicted in FIG. 1. The body rails 14, 16 can be any length and they can be any shape, size or design. FIG. 1 depicts the body rails 14, 16 exploded from the slider box assembly 10 for clarity.

Typically, the body rails 14, 16 are at least partially engaged with one or more clips 15 on the slider box assembly 10. The clips 15 slideably engage at least partially with a bottom portion the body rails 14, 16. The present invention is not limited only to connecting the slider box assembly 10 to the body rails 14, 16 with clips 15 as other means are well within the scope of the present invention.

The first and second body rails 14, 16 are typically attached to the base (not shown) of a semi-trailer. The rails 14, 16 extend substantially parallel to one another on the semi-trailer.

The rails 14, 16 each have a plurality of holes 18. The holes 18 receive lock pins 20, which will be described in more detail below, of the slider box assembly 10. The lock pins 20 selectively secure the slider box assembly 10 to the semi-trailer frame 12.

The slider box assembly 10 comprises a first slider rail 22 and a second slider rail 24. FIG. 1 depicts one embodiment of the slider rails 22, 24. The slider rails 22, 24, however, can be any shape, size or design. Regardless of their shape, size or design, the slider rails 22, 24 have a complementary shape to the body rails 14, 16 so that the slider rails 22, 24 can slidably support the body rails 14, 16. For example, the slider rails 22, 24 can fit entirely or partially within the body rails 14, 16.

A low friction material 25 may be located on the slider rails 22, 24 and/or the body rails 14, 16 where the two types of rails 14, 16, 22, 24 contact one another. In the depicted embodiment in FIG. 1, the low friction material 25 comprises a high density polyethylene. The present invention, however, is not limited to this material 25 and other materials having similar properties are within the scope of the present invention.

The slider box assembly 10 supports one or more hanger brackets 26 as known in the art. The hanger brackets 26 support axle/suspension systems (not shown) for the trailer.

FIG. 1 depicts cross members 28 extending between the first and second slider rails 22, 24. While four cross members 28 are depicted having one shape, size and design and a particular spacing between them, such a disclosure should not be considered limiting to the present application. Instead, any number of cross members 28 having any shape, size or design may be used.

An actuator bar 30 preferably extends substantially perpendicularly to the cross members 28 and substantially parallel to the first and second slider rails 22, 24. As shown in the figure, the actuator bar 30 may be located substantially equidistant from the first and second slider rails 22, 24, although the actuator bar 30 can be located anywhere between the rails 22, 24.

If the actuator bar 30 is located as shown in FIG. 1, it extends through apertures 32 in the cross members 28. Preferably, the actuator bar 30 is permitted to rotate in both a clockwise and counterclockwise direction within the apertures 32. Bushings 34 within the apertures 32 may facilitate the rotation of the actuator bar 30 with the cross members 28.

Attached to the actuator bar 30 are pin linkages 36, as shown in FIGS. 1, 2 and 5. Any number of pin linkages 36 may be attached to the actuator bar 30. The pin linkages 36 may be secured to the actuator bar 30 in any manner including, but not limited to, welding and/or mechanical fasteners so that the pin linkages 36 move with the actuator bar 30.

The pin linkages 36 may be located anywhere along the actuator bar 30. By way of example only, a first pin linkage 38 may be located adjacent a first end portion 40 of the actuator bar 30 and a second pin linkage 42 may be located adjacent a second end portion 44 of the actuator bar 30.

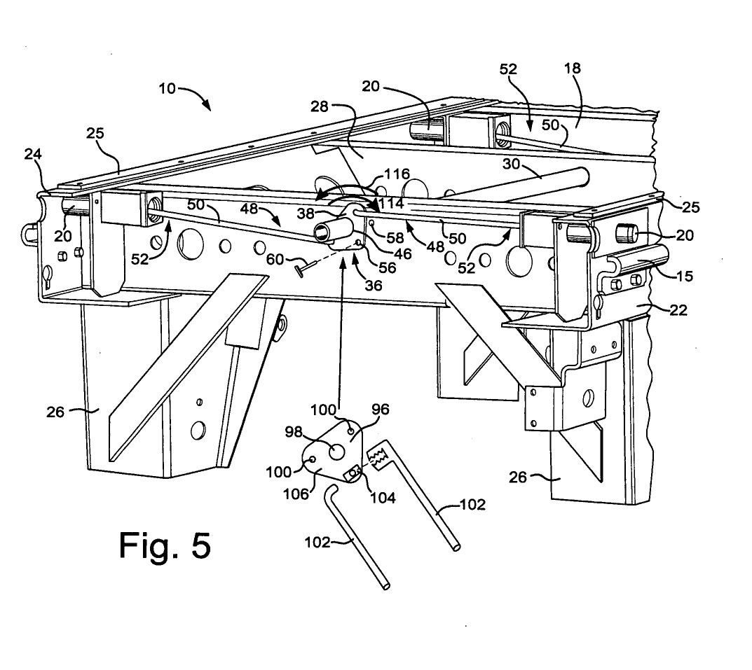

Each pin linkage 36 such as the first pin linkage 38 depicted in FIG. 5, preferably has at least one aperture 46 for receiving a first end portion 48 of a pin linkage bar 50. In the depicted embodiment, each pin linkage 36 has two apertures 46 for receiving the first end portions 48 of two pin linkage bars 50. Additional apertures may be located in one or more of the pin linkages 36 for connection with a greater number of pin linkage bars 50. All the pin linkages 36 may have apertures 46 for the same number of pin linkage bars 50 or the apertures 46 in the pin linkages 36 may vary from pin linkage 36 to pin linkage 36.

At least one pin linkage bar 50 is preferably attached to each pin linkage 36. The pin linkage bar 50 extends in a substantially perpendicular fashion from the actuator bar 30 toward one of the slider rails 22, 24. A lock pin 20 is preferably connected to the outboard end portion 52 of each pin linkage bar 50. The connection between the lock pin 20 and the pin linkage bar 50 may be a direct connection or an indirect connection with structures located between the lock pin 20 and the pin linkage bar 50.

As shown in FIGS. 1 and 5, each lock pin 20 can be selectively extended through an aperture 54 in one of the slider rails 22, 24. The extent to which the lock pin 20 needs to be extended through the aperture 54 is a function of the distance between the slider rail 22, 24 and the adjacent body rail 14, 16 and the length of the lock pin 20. It can be appreciated that the lock pin 20 should extend through the aperture 54 so that it can adequately extend through one of the apertures 18 of the body rail 14, 16 to lock the slider box assembly 10 to the body rail 14, 16.

Referring back to FIG. 5, at least one of the pin linkages 36 may also have at least one lock aperture 56. The at least one lock aperture 56 may be located anywhere on the pin linkage 36. The lock aperture 56 can be selectively aligned with an aperture 58 in one of the cross members 28. For example, the lock aperture 56 can be located in the pin linkage 36 such that when the pin linkage 36 is rotated a predetermined amount, such as an amount required for the lock pins 20 to disengage the body rails 14, 16, the lock aperture 56 aligns with the aperture 58 in the cross member 28. A locking pin 60 can be located through the lock aperture 56 and into the aperture 56 of the cross member 28 so that the pin linkage 36 cannot move. One or more lock apertures 56 can be located in one or more pin linkages 36.

The slider box assembly 10 also comprises a fluid operated bladder system 62, which is depicted in FIGS. 1, 2 and 4. The fluid may be either air or a liquid that is selectively introducible and removable into and out of a bladder body 64 of the system 62. The fluid may come from a dedicated source of pressurized fluid on the vehicle or it may be part of a pressurized fluid system that already exists on the vehicle, such as a tire inflation system or a braking system. The dedicated source of pressurized fluid or the existing system may be located on either a tractor and/or a trailer associated with the slider box assembly 10.

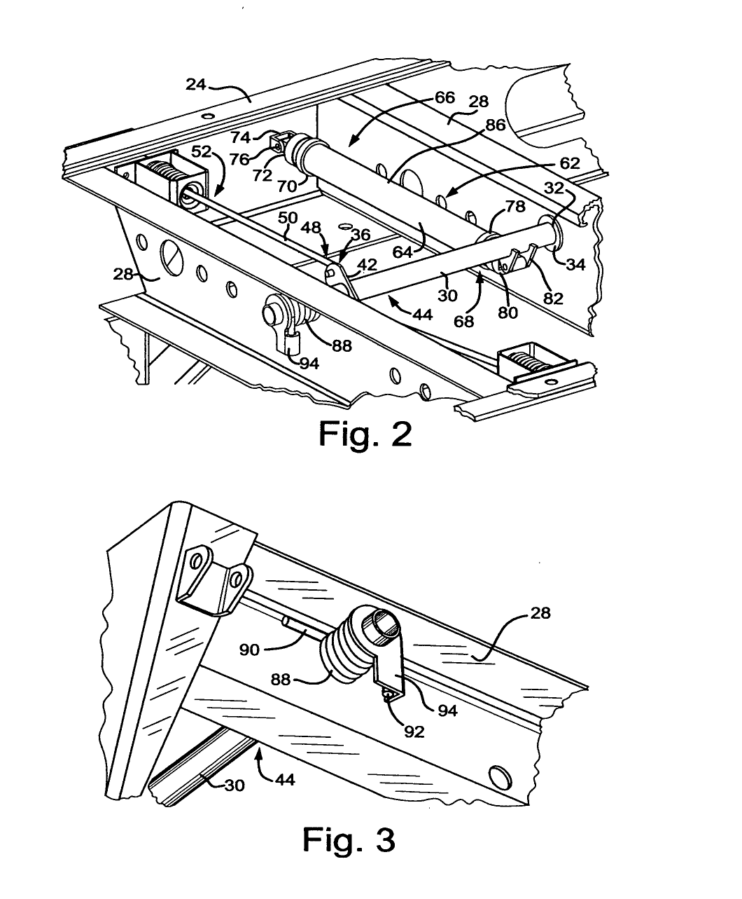

As best seen in FIG. 2, the bladder system 62 has a first end portion 66 and a second end portion 68. The first end portion 66 may be secured to one of the slider rails 22, 24. The second end portion 68 of the bladder system 62 is secured to the actuator bar 30.

The first end portion 66 of the bladder system 62 may be located anywhere along the slider rail 22, 24. One possible location of the bladder system 62 is depicted in FIG. 1 where the bladder system 62 is located adjacent a cross member 28. The cross member 28 assists in counter-acting a bending load generated by the bladder system 62 during its operation. It can be appreciated that the bladder system 62 need not be located adjacent a cross member 28, however, depending on the load that the bladder system 62 generates and/or on the particular structure of the slider box assembly 10.

It is also within the scope of the present invention to attach the first end portion 66 of the bladder system to one of the hanger brackets 26.

Referring back to FIG. 2, the first end portion 66 of the bladder system 62 may comprise a coupling ring 70 and an adaptor 72. A bracket 74 is connected to one of the slider rails 22, 24. A pin 76 is located through the bracket 74 and adaptor 72 to permit the first end portion 66 to pivot with respect to the slider rail 22 or 24. The coupling ring 70 is located about the bladder body 64 and adaptor 72 to secure the bladder body 64 to the adaptor 72. The bracket 74 may be part of the slider rail 22, 24 or the first end portion 66 of the bladder system 62.

The source of pressurized fluid is connected through the adaptor 72, which has a fluid channel (not shown). The fluid channel communicates the fluid into an interior of the bladder body 64.

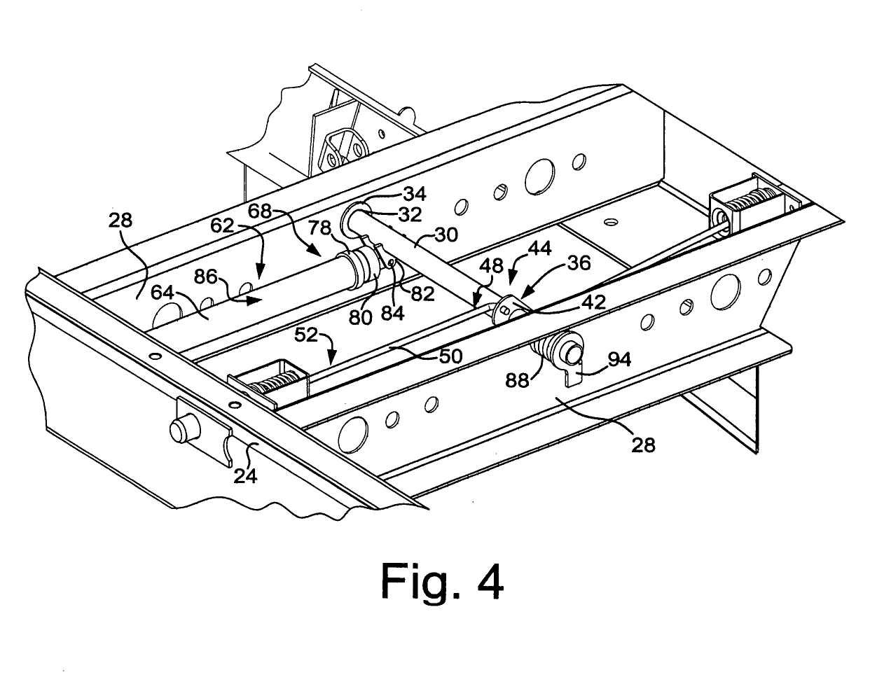

The second end portion 68 of the bladder system 62 comprises a coupling ring 78 and an adaptor 80 as may be seen in FIG. 4. The coupling ring 78 is located about the bladder body 64 and adaptor 80 to secure the bladder body 64 to the adaptor 80.

An actuator bar bracket 82 is preferably pivotally attached to the adaptor 80 by a pin 84. The actuator bar bracket 82 may be part of the actuator bar 30 or the second end portion 68 of the bladder system 62. The actuator bar bracket 82 is secured to the actuator bar 30 by welding and/or mechanical fasteners. Regardless of the method or means used to secure the actuator bar bracket 82 to the actuator bar 30, it is preferred that the bar 30 move with the bracket 82.

The actuator bar bracket 82 is depicted as being located beneath the actuator bar 30. By locating the actuator bar bracket 82 beneath the actuator bar 30, clearance issues with the bottom of the trailer may be avoided. However, it can be appreciated that the actuator bar bracket 82 can be located anywhere on the actuator bar 30.

The actuator bar bracket 82 may be a V-shape to cradle the actuator bar 30. The V-shape provides for a significant amount of area for the bracket 82 to be attached to the actuator bar 30.

The bladder body 64 may be any structure that permits fluid to come in and out and, as a result, the bladder body 64 at least lengthens and contracts. For example, the bladder body 64 may be an elastomeric material, such as synthetic rubber or the like.

The exterior of the bladder body 64 may be covered with a protective structure 86 to prevent it from being damaged. Such a structure 86 may comprise metal, composite materials and/or polymer strands, fibers or sections that are woven or non-woven.

The protective structure 86 may also assist in the performance of the bladder system 62. Specifically, the weave and/or location of the protective structure 86 may assist in the direction and amount the bladder system 62 moves when inflated and deflated.

For example, when fluid enters the bladder system 62, the biasing force of the weave and/or the location of the structure on the bladder body 64, causes the bladder body 64 to expand radially thus pulling its end portion 68 substantially longitudinally inward. When fluid leaves the system 62, it contracts radially thus permitting the end portion 68 to extend substantially longitudinally.

As can be seen in FIGS. 14, adjacent one end portion of the actuator bar 30, such as the second end portion 44 as shown in the figures, a torsion spring 88 is located in contact with the actuator bar 30. The torsion spring 88 may be located about the actuator bar 30 or otherwise acting on it via intermediary structures. When the torsion spring 88 is located about one end portion of the actuator bar 30, it may be located adjacent one of the cross rails 28 so that it can react against the cross rail 28.

In this exemplary embodiment, one leg 90 of the torsion spring 88 may be located against the cross rail 28 and the other leg 92 of the torsion spring 88 may be located against a bracket 94 attached to the actuator bar 30. Regardless of how the torsion spring 88 is connected to the actuator bar 30, or where it is connected to the actuator bar 30, the torsion spring 88 can provide a rotational biasing force to the actuator bar 30. The rotational biasing force is particularly beneficial during manual rotation of the actuator bar 30, which is described below.

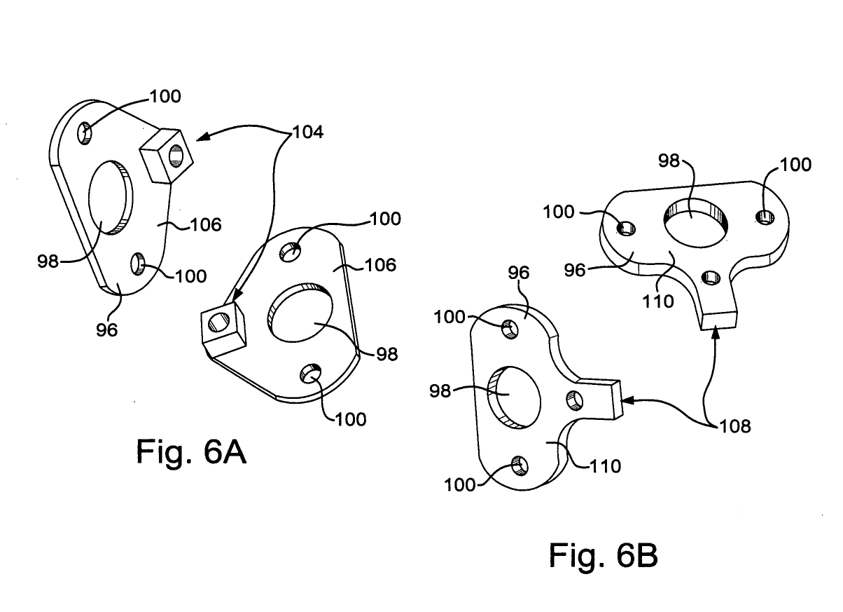

A handle linkage 96, such as those depicted in FIGS. 6A-6B, may be attached to the actuator bar 30. The handle linkage 96 may be attached anywhere on the actuator bar 30, such as adjacent the first end portion 40 of the actuator bar 30. The handle linkage 96 may replace the pin linkage 38 on the first end portion 40 of the actuator bar 30. The handle linkage 96 has an aperture 98 for receiving the actuator bar 30 and the handle linkage 96 may be secured to the actuator bar 30 by welding and/or mechanical fasteners. The handle linkage 96 may have one or more pin linkage bar apertures 100 for receiving one or more pin linkage bars 50.

The handle linkage 96 may have an adaptor for connection with a removable handle 102. For example, the handle linkage 96 depicted in FIG. 6A has an adaptor 104 that extends transversely to a body portion 106 of the handle linkage 96. FIG. 6B depicts a handle linkage 96 having an adaptor 108 that extends substantially planar with a body portion 110 of the handle linkage 96. Either adaptor 104, 108 may be grasped by an adjustable jaw or a non-moving jaw on the handle 102, both of which are schematically represented by the single handle 102 on FIG. 5. Alternatively, the handle 102 may have a portion that has a complementary shape to a handle aperture 112 located in both adaptors 104, 108, which is schematically represented on FIG. 5.

Regardless of the handle linkage 96 utilized, the handle 102 can be attached to the handle linkage 96 and the handle 102 can be rotated so as to rotate the actuator bar 30. Such a handle 102 may extend from the handle linkage 96 to at least one of the slider rails 22, 24, if not further outboard.

The handle 102 may be removable so that if the actuator bar 30 is moved by the bladder system 62, the handle 102 will not undesirably come in contact with an operator of the system or the vehicle.

One method of engaging and disengaging the slider box assembly 10 to and from the trailer frame 12 comprises communicating fluid, such as air, to and from the bladder system 62. When fluid is delivered to the bladder system 62 from an air system on the trailer and/or from an air system that is connected to the trailer, the bias weave on the outer surface of the bladder body 64, as well as the shape of the bladder body 64 and/or its elastomeric construction causes the bladder body 64 to increase in diameter and decrease in length. The bladder system 62, being connected at one end portion to the actuator bar 30, pulls the actuator bar 30 as the bladder body 64 increases in diameter and decreases in length, thus rotating it in a first direction 114. The pin linkages 36 rotate with the actuator bar 30. The pin linkage bars 50, being attached to the pin linkages 36, move the lock pins 20 out of locking engagement with the body rails 14, 16. The slider box assembly 10, being unlocked from the body rails 14, 16, can now be moved to adjust the load on the axle or axles.

Fluid can be exhausted from the bladder system 62 by exposing the bladder system 62 to atmospheric pressure. A vacuum source located on the trailer and/or by a vacuum source connected to the trailer can be used to exhaust fluid from the bladder system 62. The bladder body 64 decreases in diameter and increases in length when the fluid is exhausted. The torsion spring 88 pushes the actuator bar 30, thus rotating it in a second direction 116. The pin linkages 36 move with the actuator bar 30, which move the pin linkage bars 50 so that the lock pins 20 are forced into engagement with the body rails 14, 16. The slider box assembly 10 is then engaged with the body rails 14, 16.

The slider box assembly 10 may also be engaged and disengaged to and from the body rails 14, 16 manually. FIG. 5 depicts a handle linkage 96 that can be located on the actuator bar 30 in place of the pin linkage 38. While FIG. 5 depicts one of the handle linkages shown in FIGS. 6A and 6B, either linkage, or other linkages, may be used. One end of the handle 102 is attached to the handle linkage 96. An operator grasps the other end of the handle 102 and rotates the handle 102 in the first direction 114, which corresponds to the first direction 114 of rotation of the actuator bar 30, or the second direction 116, which corresponds to the second direction 116 of rotation of the actuator bar 30. The actuator bar 30 functions as described above to move the pin linkages 36, the pin linkage bars 50 and the lock pins 20 into and out of engagement with the trailer pins 14, 16. The torsion spring 88 provides assistance to the operator to rotate the actuator bar 30, move the pin linkage bars 50 and the lock pins 20.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A slider box assembly, comprising:
a first slider rail and a second slider rail;
an actuator bar having a first end portion and a second end portion, said actuator bar extending substantially midway between and substantially parallel to said slider rails, said actuator bar connected to a plurality of pin linkage bars;
a handle linkage secured adjacent said first end portion of said actuator bar, said handle linkage removably receiving a handle;
a torsion spring located about said second end portion of said actuator bar;
a bladder system having a first end portion secured directly to said actuator bar and a second end portion connected to one of said slider rails.

2. The assembly of claim 1, wherein said actuator bar is mounted for rotation within at least two cross members, said cross members extending between said first slider rail and said second slider rail.

3. The assembly of claim 1, wherein at least one pin linkage is located about and secured to said actuator bar for movement with said actuator bar.

4. The assembly of claim 3, wherein a first pin linkage bar and a second pin linkage bar are attached to said at least one pin linkage, said pin linkage bars being connected to lock pins.

5. The assembly of claim 1, wherein at least one of said pin linkages has an aperture for receiving a lock pin, said lock pin extending through said aperture to one of said cross members.

6. The assembly of claim 1, wherein said handle linkage has an adaptor for removeably receiving said handle.

7. The assembly of claim 1, wherein said torsion spring rotationally biases said actuator bar to move said pin linkage bars such that said lock pins are moved outward.

8. The assembly of claim 1, wherein said second end portion of said bladder system has a pivotal bracket that is under-mounted to said actuator bar.

9. A slider device for a vehicle, comprising:
a slider box assembly comprising a first slider rail and a second slider rail, said slider rails being substantially parallel with one another, and at least one cross member extending transversely from said first slider rail to said second slider rail;
a rotatable actuator bar extending between and substantially parallel to said slider rails, said actuator bar extending through said cross member;
a bladder system having a first end portion and a second end portion, said bladder system being located adjacent to and substantially parallel to said at least one cross member, said first end of said bladder system being secured to one of said slider rails and said second end portion of said bladder system being secured to a bottom portion of said actuator bar with a pivoting bracket.

10. The slider device of claim 9, wherein said bladder system comprises a single bladder body.

11. The slider device of claim 9, wherein said bladder system extends substantially transversely between said slider rails and said actuator bar.

12. The slider device of claim 10, wherein said bladder body is an axially and radially expandable and contractible tube.

13. A method of engaging and disengaging a slider box assembly from a trailer frame, comprising:
providing a slider box assembly, comprising:
a. at least two slider rails slidably engaged with a trailer frame;
b. an actuator bar connected to at least one lock pin;
providing an inflatable and deflatable bladder system that has a first end portion secured in a non-movable fashion to one of said slider rails and a second end portion connected to said actuator bar;
inflating said bladder system to rotate said actuator bar in a first direction to move said at least one lock pin away from said slider rails; and
deflating said bladder system to rotate said actuator bar in a second direction to move said at least one lock pin toward said slider rails.

14. The method of claim 13, wherein said second end portion of said bladder system is pivotally engaged with an underside of said actuator bar.

15. The method of claim 13, wherein when said bladder system is inflated said bladder system axially contracts and when said bladder system is deflated said bladder system axially expands.

16. The method of claim 13, wherein said at least one lock pin is moved away from and toward said slider rails by a manually operated handle removably attached to a handle linkage adjacent a first end portion of said actuator bar.

17. The method of claim 13, wherein a torsion spring located adjacent a second end portion of said actuator bar biases said actuator bar in said second direction.

18. The method of claim 13, wherein said bladder system has a single bladder body that rotates said actuator bar.
